(19) United States
(12) Patent Application Publication
(10) Pub. No.: US 2024/0424512 A1
(43) Pub. Date: Dec. 26, 2024

(54) CONTROL METHOD FOR ADHESIVE APPLYING DEVICE AND ADHESIVE APPLYING DEVICE

(71) Applicant: CONTEMPORARY AMPEREX TECHNOLOGY CO., LIMITED, Ningde City (CN)

(72) Inventors: Yafei Shen, Ningde (CN); Fanke Chen, Ningde (CN); Xueqing Gong, Ningde (CN)

(73) Assignee: CONTEMPORARY AMPEREX TECHNOLOGY CO., LIMITED, Ningde City (CN)

(21) Appl. No.: 18/417,978

(22) Filed: Jan. 19, 2024

Related U.S. Application Data
(63) Continuation of application No. PCT/CN2023/101877, filed on Jun. 21, 2023.

(51) Int. Cl. B05B 12/08

(52) U.S. Cl. CPC B05B 12/08

(57) ABSTRACT

Embodiments of the present disclosure provides a control method for an adhesive applying device. The adhesive applying device includes an adhesive dispensing module, a first moving mechanism and a testing module. The control method includes performing a testing inspection operation, which includes: moving, by the first moving mechanism, an adhesive nozzle in the adhesive dispensing module to a first position aligned with the testing module, instructing the adhesive dispensing module to discharge a first amount of adhesive from the adhesive nozzle, receiving a second amount from the testing module, where the second amount is obtained based on measuring the received adhesive using the testing module, and determining that the adhesive applying device passes the testing inspection in the case where a deviation of the second amount relative to the first amount does not exceed a first threshold.

### CROSS REFERENCE TO RELATED APPLICATION

This application is a continuation of International Patent Application No. PCT/CN2023/101877, filed on Jun. 21, 2023, which is incorporated by reference in its entirety.

### TECHNICAL FIELD

The present disclosure relates to the technical field of adhesive applying, and in particular, to a control method for an adhesive applying device and an adhesive applying device.

### BACKGROUND

Adhesive applying refers to a process of covering a product with a fluid such as a glue by dispensing, injecting, or spreading. The adhesive applying process is a common part of a production process in various industries. Taking production of power batteries as an example, in order to dissipate the large amount of heat generated during the use of power batteries, the power batteries are often fixedly connected to a cooling structure in the form of surface contact, so that the heat of the power batteries is dissipated by means of heat conduction to maintain the batteries at a suitable operating temperature. The process usually involves first applying an adhesive on an outer case of a power battery, and then attaching the cooling structure onto a surface of the case of the power battery that is applied with the adhesive. The quality of adhesive applying will affect the subsequent heat dissipation effect of the battery. As the production process becomes digitized and intelligent, it is desirable to increase the degree of automation of the adhesive applying process and still ensure the quality of adhesive applying, such as the precision and/or reliability of adhesive applying.

However, some of the relevant adhesive applying technologies still rely on manual operation, which are difficult to achieve a high degree of automation, while others are partially automated with a failure in ensuring the quality of adhesive applying.

### SUMMARY

In view of the above problems, the present disclosure provides a control method for an adhesive applying device and an adhesive applying device, for improving the quality of automatic adhesive applying.

In a first aspect, the present disclosure provides a control method for an adhesive applying device. The adhesive applying device includes an adhesive dispensing module, a first moving mechanism and a testing module. The control method includes performing a testing inspection operation, which includes: moving, by the first moving mechanism, an adhesive nozzle in the adhesive dispensing module to a first position aligned with the testing module, instructing the adhesive dispensing module to discharge a first amount of adhesive from the adhesive nozzle, and receiving a second amount from the testing module, wherein the second amount is obtained based on measuring the received adhesive using the testing module, and determining that the adhesive applying device passes the testing inspection in the case where a deviation of the second amount relative to the first amount does not exceed a first threshold.

In a technical solution of embodiments of the present application, by controlling the adhesive dispensing module to discharge a first amount of adhesive to the testing module from the adhesive nozzle and receiving a second amount obtained by measuring the received adhesive using the testing module, it is determined that the adhesive applying device passes the testing inspection in the case where a deviation of the second amount relative to the first amount does not exceed the first threshold. In this way, the adhesive applying device can be controlled to automatically complete a first article inspection, thereby improving the efficiency of the first article inspection and reducing labor costs. Accordingly, while improving production efficiency and reducing labor costs, the frequency of the first article inspection can be adaptively adjusted according to the actual situation, so that the accuracy of the amount of adhesive discharged in the automatic adhesive applying process can be improved, and the quality of automatic adhesive applying can be improved.

In some embodiments, the testing inspection operation is performed when the fulfillment of a first criterion is detected. The first criterion includes at least one of initial start of the adhesive applying device; a first preset duration since the last execution of the testing inspection operation; and a change in the type of a product to be applied with adhesive. Performing the testing inspection operation after the fulfillment of the first criterion is detected can further improve the accuracy of the amount of adhesive discharged in the automatic adhesive applying process, which can further improve the quality of automatic adhesive applying.

In some embodiments, the control method further includes obtaining, from a first remote control system, information about the change in the type of the product to be applied with adhesive. In an actual production line, information of the product to be applied with adhesive is often recorded in a remote inventory management system or a production line process control system, not in the local adhesive applying device. By obtaining, from the remote control system, information about the change in the type of the product to be applied with adhesive, it is possible to reduce the number of cases in which the adhesive applying device is operated by manually checking the change in product type.

In some embodiments, the first amount is determined based on a dimension of the adhesive nozzle. The first amount is flexibly adjusted based on the dimension of the adhesive nozzle, rather than a fixed value. This enables the adhesive dispensing module to complete the discharging of the first amount of adhesive in a short time under the condition of different sizes of adhesive nozzles. In this way, the time required for performing the testing inspection operation can be reduced, the efficiency of performing the testing inspection can be improved, and thus the production efficiency can be improved.

In some embodiments, the adhesive dispensing module includes a metering module, the metering module being configured to meter the adhesive delivered to the adhesive nozzle; the control method further includes: in response to determining via the metering module that the discharging of the first amount of adhesive has been completed, instructing the testing module to measure the received adhesive to obtain the second amount. In this way, it can be ensured that the testing module measures the received adhesive only when the first amount of adhesive is completely discharged, so that the more accurate second amount can be obtained.

In some embodiments, the testing module is configured to detect whether or not the discharging of the first amount of adhesive has been completed; and in response to detecting that the discharging of the first amount of adhesive has been completed, measuring the received adhesive to obtain the second amount. In this way, the testing module can automatically measure the received adhesive to obtain the second amount without external control, thereby reducing signaling interaction.

In some embodiments, the control method further includes: in response to determining that the testing inspection is passed, moving, by the first moving mechanism, the adhesive nozzle from an initial position to an adhesive applying starting position of a product to be applied with adhesive; and driving, by the first moving mechanism, the adhesive nozzle to move in a track, and instructing the adhesive dispensing module to discharge a third amount of adhesive from the adhesive nozzle to apply the adhesive on the product to be applied with adhesive. In this way, automatic adhesive applying for the product to be applied with adhesive can be realized.

In some embodiments, the adhesive dispensing module further includes a metering module, the metering module being configured to meter the adhesive delivered to the adhesive nozzle; the control method further includes: determining, based on the metering of the metering module, a fourth amount of the adhesive delivered to the adhesive nozzle during adhesive applying for the product to be applied with adhesive; and instructing the adhesive dispensing module to stop applying the adhesive on a next product to be applied with adhesive in the case where a deviation of the fourth amount relative to the third amount exceeds a second threshold. In this way, the quality of the adhesive applying process can be automatically controlled to reduce the cost of errors caused by poor quality of adhesive applying.

In some embodiments, the control method further includes uploading the fourth amount to a second remote control system. By uploading the fourth amount to the second remote control system, it may facilitate the subsequent traceability of production data and may also help production personnel to view the production data remotely.

In some embodiments, the control method further includes obtaining the third amount from a third remote control system based on the type of the product to be applied with adhesive. For example, the production personnel can preset a corresponding relationship between the product type and the amount of adhesive in the remote control system. By obtaining the adhesive amount information corresponding to the product type from the remote control system, the necessity of manual verification at the site of the adhesive applying device can be reduced.

In some embodiments, the control method further includes moving, by the first moving mechanism, the adhesive nozzle to return to the initial position after the adhesive applying is completed. In this way, it is possible to prevent the adhesive nozzle from colliding with the product due to being retained in an adhesive application position, thereby improving the reliability of the adhesive applying device and the product.

In some embodiments, the control method further includes: after the adhesive applying is completed, instructing a second moving mechanism to transfer the product that has been applied with adhesive away from the adhesive applying position. In this way, the possibility of the adhesive nozzle colliding with the product can be reduced, thereby improving the reliability of the adhesive applying device and the product. Moreover, an adhesive applying station can be quickly vacated automatically, without manual carrying, reducing the time for the adhesive applying device to wait for a next product to be applied with adhesive, and improving the continuity of operation.

In some embodiments, the control method further includes instructing the second moving mechanism to transfer the product to be applied with adhesive to the adhesive applying position before transferring the adhesive nozzle from the initial position to the adhesive applying starting position by the first moving mechanism. In this way, it is beneficial to realize the streamlined production of products.

In some embodiments, the control method further includes: in response to determining that the product to be applied with adhesive has reached the adhesive applying position, obtaining an image of the product to be applied with adhesive by an image acquisition apparatus; and determining the adhesive applying starting position based on the image. The real image of the product that has reached the adhesive applying position can be acquired on-site by the image acquisition apparatus, so that the adhesive applying starting position can be determined more accurately and the accuracy of adhesive applying can be improved.

In some embodiments, the adhesive applying device further includes an adhesive discarding module; the control method further includes performing an adhesive discarding operation, which includes moving, by the first moving mechanism, the adhesive nozzle to a second position aligned with the adhesive discarding module; and instructing the adhesive dispensing module to discharge a fifth amount of adhesive from the adhesive nozzle. In this way, the adhesive applying device can be controlled to automatically discharge discarded adhesive without manual operation, thereby reducing labor costs.

In some embodiments, the adhesive discarding operation is performed when the fulfillment of a second criterion is detected, where the second criterion includes that no adhesive is discharged from the adhesive nozzle within a second preset duration. In this way, the possibility of the adhesive nozzle being blocked due to the solidification of the adhesive can be reduced, thereby improving the reliability of the adhesive applying device.

In some embodiments, the fifth amount is associated with a duration in which no adhesive is discharged since the last discharging of adhesive from the adhesive nozzle. The fifth amount is flexibly adjusted based on the duration in which no adhesive is discharged since the last discharging of adhesive from the adhesive nozzle, rather than a fixed value. In this way, the possibility of the adhesive nozzle being blocked due to the solidification of the adhesive can be reduced, thereby improving the reliability of the adhesive applying device.

In a second aspect, the present disclosure provides a control method for an adhesive applying device. The adhesive applying device includes an adhesive dispensing module and a first moving mechanism. The control method includes: in response to determining that a product to be applied with adhesive has reached an adhesive applying position, obtaining a first image of the product to be applied with adhesive by an image acquisition apparatus; and determining, based on the first image and dimension information, a plurality of coordinates that define an adhesive applying area of the product to be applied with adhesive, the plurality of coordinates including a first starting point coordinate and a first ending point coordinate in a first direction, and a second starting point coordinate and a second ending point coordinate in a second direction; moving, by the first moving mechanism, an adhesive nozzle in the adhesive dispensing module from an initial position to an adhesive applying starting position of the product to be applied with adhesive, where the adhesive applying starting position is determined based on the first starting point coordinate and the second starting point coordinate; and driving, by the first moving mechanism, the adhesive nozzle to move in a track to an adhesive applying ending position, and instructing the adhesive dispensing module to discharge a preset amount of adhesive from the adhesive nozzle, to apply the adhesive on the product to be applied with adhesive, where the adhesive applying ending position is determined based on the first starting point coordinate and the second ending point coordinate. In this way, the adhesive nozzle can be controlled by the first moving mechanism to accurately move from the adhesive applying starting position to the adhesive applying ending position in a track. In this way, the degree of automation and the quality of adhesive applying can be improved.

In some embodiments, the control method further includes obtaining, by the image acquisition apparatus, a second image of the product that has been applied with adhesive after the adhesive applying is completed; determining, based on the second image, a first area in which the adhesive is applied; and in the case where the first area is smaller than a second area of the product required to be applied with adhesive, instructing the adhesive dispensing module to continue to discharge adhesive from the adhesive nozzle to supplement the adhesive to apply it on the product. In this way, when the area applied with adhesive does not meet the requirements, the adhesive can be supplemented to apply on the product in time.

In some embodiments, the first moving mechanism drives the adhesive nozzle at a first velocity to move in the track, the first velocity being determined based on a second velocity, the second velocity being a velocity at which the adhesive dispensing module discharges the preset amount of adhesive from the adhesive nozzle. By associating a moving velocity of the adhesive nozzle with an adhesive discharging velocity, the discharging of the preset amount of adhesive can be realized more accurately, thereby meeting the quality requirements for adhesive applying.

In some embodiments, the area to be applied with adhesive belongs to a first surface of the product to be applied with adhesive, the dimension information includes first information and second information, the first information indicating a distance between a boundary of the area to be applied with adhesive and a boundary of the first surface, and the second information indicating a dimension of the adhesive nozzle.

In some embodiments, the area to be applied with adhesive includes a plurality of sub-areas, two adjacent sub-areas of the plurality of sub-areas being spaced apart by an opening in the first surface, and the dimension information further includes third information indicating the dimension and location of the opening. In this way, in the case where the surface of the product to be applied with adhesive has the opening, an adhesive applying track can still be accurately calculated.

In a third aspect, the present disclosure provides an adhesive applying device, including an adhesive dispensing module, the adhesive dispensing module including an adhesive nozzle, and the adhesive dispensing module being configured to discharge adhesive via the adhesive nozzle; a first moving mechanism configured to move the adhesive nozzle of the adhesive dispensing module to a specified position; a testing module configured to receive and measure the adhesive; and a control module communicatively coupled to the adhesive dispensing module, the first moving mechanism and the testing module and configured to execute program instructions to perform the control method according to any one of the embodiments of the first aspect.

In a fourth aspect, the present disclosure provides an adhesive applying device, including an adhesive dispensing module, the adhesive dispensing module including an adhesive nozzle and being configured to discharge adhesive via the adhesive nozzle; a first moving mechanism configured to move the adhesive nozzle of the adhesive dispensing module to a specified position; and a control module communicatively coupled to the adhesive dispensing module and the first moving mechanism and configured to execute program instructions to perform the control method according to any one of the embodiments of the second aspect.

### BRIEF DESCRIPTION OF DRAWINGS

Various other advantages and benefits will become apparent to those of ordinary skill in the art upon reading the following detailed description of the preferred embodiments. The drawings are for the purpose of illustrating the preferred embodiments only and are not to be considered a limitation to the present application. In addition, the like components are denoted by the like reference numerals throughout the drawings. In the drawings,

FIG. 1 is a schematic structural diagram of an adhesive applying device according to some embodiments of the present disclosure;

FIG. 2 is a schematic flowchart of a control method for an adhesive applying device according to some embodiments of the present disclosure;

FIG. 3 is a schematic flowchart of a control method for an adhesive applying device according to some other embodiments of the present disclosure;

FIG. 4 is a schematic flowchart of a control method for an adhesive applying device according to yet some other embodiments of the present disclosure;

FIG. 5 is a schematic flowchart of a control method for an adhesive applying device according to still some other embodiments of the present disclosure;

FIG. 6 is a schematic diagram of a first image according to some embodiments of the present disclosure; and

FIG. 7 is a schematic diagram of an operating procedure of an adhesive applying device according to some embodiments of the present disclosure.

The drawings are not drawn to actual scale.

### DETAILED DESCRIPTION

The following further describes the implementations of the present disclosure in detail with reference to the drawings and embodiments. The following detailed description of the embodiments and the drawings are used to illustrate the principles of the present disclosure by way of example, but should not be used to limit the scope of the present disclosure, that is, the present disclosure is not limited to the described examples.

In the description of the present disclosure, it should be noted that, unless otherwise stated, “a plurality of” means two or more; the orientation or positional relationships indicated by the terms “upper”, “lower”, “left”, “right”, “inner” and “outer” are only for facilitating the description of the present disclosure and simplifying the description, rather than indicating or implying that the apparatus or element referred to must have a particular orientation or be constructed and operated in a particular orientation, and therefore will not be interpreted as limiting the present disclosure. In addition, the terms “first”, “second”, “third”, and the like are merely for the purpose of description and shall not be understood as any indication or implication of relative importance. “Perpendicular” is not perpendicular in the strict sense but within an allowable range of error. “Parallel” is not parallel in the strict sense but within an allowable range of error.

The orientation terms appearing in the following description all are directions shown in the figures, and do not limit the particular structure of the present disclosure. In the description of the present disclosure, it should also be noted that unless otherwise specified and defined explicitly, the terms “mount”, “connect”, and “join” should be understood in their general senses. For example, they may refer to a fixed connection, a detachable connection, or an integral connection, and may refer to a direct connection or an indirect connection via an intermediate medium. For those of ordinary skill in the art, the particular meanings of the above terms in the present disclosure may be understood according to particular circumstances.

One of the reasons analyzed for the low quality of automatic adhesive applying in related technologies is the inaccurate amount of adhesive discharged in the automatic adhesive applying process. Some technologies use a method of manual first article inspection to improve the accuracy of the amount of discharged adhesive.

However, this method of manual first article inspection is inefficient and has high labor costs. In order to increase productivity and reduce labor costs, the frequency of first article inspection is low. This leads to the possibility that the accuracy of the amount of discharged adhesive may fluctuate over time in the automatic adhesive applying process, and even if there is an inaccuracy in the amount of adhesive, it cannot be detected in time, thus affecting the quality of automatic adhesive applying.

In view of the above, the present disclosure provides a control method for an adhesive applying device, which can control the adhesive applying device to automatically perform a first article inspection.

Compared to the method of manual first article inspection, this method can improve the efficiency of the first article inspection and reduce the labor costs, and accordingly can improve the frequency of the first article inspection while increasing the production efficiency and reducing the labor costs. In this way, the accuracy of the amount of discharged adhesive in the automatic adhesive applying process can be improved, and thus the quality of the automatic adhesive applying can be improved.

For ease of understanding, the adhesive applying device according to some embodiments of the present disclosure is first described.

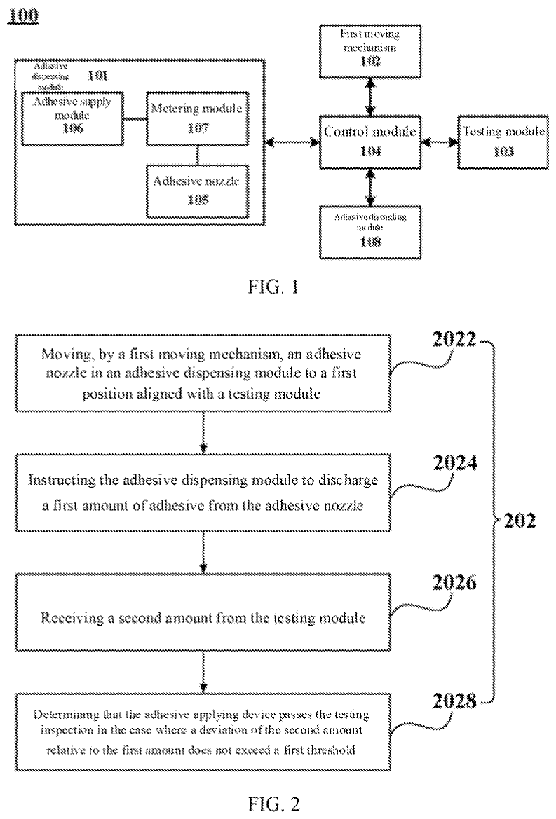

FIG. 1 is a schematic structural diagram of an adhesive applying device according to some embodiments of the present disclosure.

Referring to FIG. 1, an adhesive applying device 100 includes an adhesive dispensing module 101. The adhesive dispensing module 101 at least includes an adhesive nozzle 105. The adhesive dispensing module 101 is configured to discharge adhesive via the adhesive nozzle 105.

The adhesive applying device 100 further includes a first moving mechanism 102. The first moving mechanism 102 is configured to move the adhesive nozzle 105 in the adhesive dispensing module 102 to a specified position.

In some embodiments, the first moving mechanism 102 may be a robot. The robot may clamp the adhesive nozzle to move the adhesive nozzle to the specified position.

The adhesive applying device 100 further includes a testing module 103. The testing module 103 is configured to receive and measure the adhesive.

In some embodiments, the testing module 103 may include a container (e.g., an adhesive box) for containing the received adhesive. As some implementations, the testing module 103 further includes a device for weighing the container to measure the received adhesive.

In some implementations, the adhesive nozzle 105 can store a certain amount of adhesive on its own and discharge it. In other embodiments, the adhesive dispensing module 101 includes a separate adhesive supply module 106, the adhesive supply module 106 supplying the adhesive to the adhesive nozzle via an adhesive delivery apparatus (not shown in FIG. 1). The adhesive delivery device may, for example, include a hose. The adhesive supply module 106 may include a container (e.g., a drum container) for storing the adhesive. The adhesive supply module 106 may further include a pump for delivering the adhesive.

As some implementations, the adhesive supply module 106 may further include an agitator for agitating the adhesive to be delivered to the adhesive nozzle 105 so as to remove air from the adhesive.

In some implementations, the adhesive dispensing module 101 may further include a metering module 107. The metering module 107 can be configured to meter the adhesive delivered to the adhesive nozzle. As an example, the metering module 107 may be arranged between the adhesive supply module 106 and the adhesive nozzle 105 as shown in FIG. 1, and is fluidly connected to the both through the adhesive delivery apparatus. The metering module 107 may also be disposed within the adhesive nozzle 105 differently than shown in FIG. 1 in the case where the adhesive nozzle 105 stores the adhesive on its own and discharges the adhesive.

The adhesive applying device 100 may further include a control module 104. The control module 104 is configured to communicate with other modules in the adhesive applying device 100 to control other modules to perform corresponding operations. The operations performed by the control module 104 will be described in more detail later.

As some implementations, the control module 104 may be a Programmable Logic Controller (PLC).

It should be understood that the manner of integrating the control module 104 into the adhesive applying device 100 is only one implementation. In some other implementations, the control module 104 may also be independent of the adhesive applying device 100.

The adhesive applying device 100 further includes an adhesive discarding module 108. The adhesive discarding module 108 is configured to receive the adhesive. For example, the adhesive discarding module 108 may further include a container for containing the adhesive.

It is to be understood that the adhesive applying device 100 shown in FIG. 1 is illustrative and not limiting. The adhesive applying device of the present disclosure may include one or more modules of the adhesive applying device 100.

It is also to be understood that the adhesive applying device disclosed in the embodiments of the present disclosure may, but is not limited to, apply adhesive on batteries. The batteries may include, but are not limited to, cells, battery modules, battery packs, and the like. A battery pack may include, but is not limited to, a lower case thereof.

Thus far, the adhesive applying device of the present disclosure has been briefly described. A control method for an adhesive applying device according to some embodiments of the present disclosure is described below with reference to FIGS. 2 to 5.

FIG. 2 is a schematic flowchart of a control method for an adhesive applying device according to some embodiments of the present disclosure. The adhesive applying device at least includes the adhesive dispensing module 101, the first moving mechanism 102, and the testing module 103 shown in FIG. 1.

As shown in FIG. 2, the control method for an adhesive applying device includes step 202. At step 202, a testing inspection operation is performed. Step 202 includes steps 2022 to 2028.

At step 2022, an adhesive nozzle in the adhesive dispensing module is moved to a first position aligned with the testing module by the first moving mechanism.

For example, the testing module may include a container for containing the adhesive, with an opening provided on the upper side of the container. In this case, the adhesive nozzle can be moved by the first moving mechanism to a position directly above the opening of the container in the testing module (i.e., a first position).

At step 2024, the adhesive dispensing module is instructed to discharge a first amount of adhesive from the adhesive nozzle.

For example, the adhesive discharged from the adhesive nozzle is received by the container in the testing module.

At step 2026, a second amount is received from the testing module. The second amount is obtained based on measuring the received adhesive using the testing module.

As some implementations, the testing module is configured to detect whether or not the discharging of the first amount of adhesive has been completed; and in response to detecting that the discharging of the first amount of adhesive has been completed, measuring the received adhesive to obtain the second amount. In this way, the testing module can automatically measure the received adhesive to obtain the second amount without external control, thereby reducing signaling interaction.

As some other implementations, in response to determining via the metering module that the discharging of the first amount of adhesive has been completed, the testing module is instructed to measure the received adhesive to obtain the second amount. In this way, it can be ensured that the testing module measures the received adhesive only when the first amount of adhesive is completely discharged, so that the more accurate second amount can be obtained.

As some implementations, the second amount may also be uploaded to a particular remote control system. The remote control system may be, for example, a Total Order Management (TOM) system or a Manufacturing Execution System (MES).

At step 2028, it is determined that the adhesive applying device passes the testing inspection in the case where a deviation of the second amount relative to the first amount does not exceed a first threshold.

The deviation of the second amount relative to the first amount does not exceed the first threshold value, which indicates a small deviation between the amount of the adhesive expected to be discharged from the adhesive dispensing module and the amount of adhesive actually discharged, i.e., the accuracy of the amount of adhesive discharged from the adhesive applying device is high. In this case, it is determined that the adhesive applying device passes the testing inspection.

As some implementations, the first threshold is set sufficiently small to ensure that the accuracy of the amount of adhesive discharged from the adhesive applying device that passes the testing inspection is high enough.

As some implementations, an alarm may be issued in the case where the deviation of the second amount relative to the first amount exceeds the first threshold. In this case, production personnel can be notified in time to inspect and maintain the adhesive applying device.

in the above embodiments, by controlling the adhesive dispensing module to discharge the first amount of adhesive to the testing module from the adhesive nozzle and receiving the second amount obtained by measuring the received adhesive using the testing module, it is determined that the adhesive applying device passes the testing inspection in the case where the deviation of the second amount relative to the first amount does not exceed the first threshold. In this way, the adhesive applying device can be controlled to automatically complete a first article inspection, thereby improving the efficiency of the first article inspection and reducing labor costs. Accordingly, while improving production efficiency and reducing labor costs, the frequency of the first article inspection can be adaptively adjusted according to the actual situation, so that the accuracy of the amount of adhesive discharged in the automatic adhesive applying process can be improved, and the quality of automatic adhesive applying can be improved.

As shown in FIG. 2, the control method for an adhesive applying device is further described below in conjunction with some embodiments.

In some embodiments, step 202, i.e., performing a testing inspection operation, may be performed when the fulfillment of a first criterion is detected.

As some implementations, the first criterion may refer to initial start of the adhesive applying device. That is, in these implementations, the adhesive applying device performs one testing inspection operation each initial start.

As other implementations, the first criterion may refer to a first preset duration since the last execution of the testing inspection operation. That is, in these implementations, one testing inspection operation is performed every first preset duration.

As yet some other implementations, the first criterion may refer to a change in the type of a product to be applied with adhesive. That is, in these implementations, the testing inspection operation is performed once for each change in type of the product to be applied with adhesive.

In the above embodiments, performing the testing inspection operation after the fulfillment of the first criterion is detected can further improve the accuracy of the amount of adhesive discharged in the automatic adhesive applying process, which can further improve the quality of automatic adhesive applying.

In some embodiments, information about the change in the type of the product to be applied with adhesive may be obtained from the first remote control system to perform the testing inspection operation when the information about the change in the type of the product to be applied with adhesive is obtained. The first remote control system may be, for example, a TOM system or an MES.

In an actual production line, information of the product to be applied with adhesive is often recorded in a remote inventory management system or a production line process control system, not in the local adhesive applying device. By obtaining, from the remote control system, information about the change in the type of the product to be applied with adhesive, it is possible to reduce the number of cases in which the adhesive applying device is operated by manually checking the change in product type.

As some implementations, the first remote control system may automatically send information about the change in the type of the product to be applied with adhesive when the type of the product to be applied with adhesive changes.

As some other implementations, the first remote control system may send information about the change in the type of the product to be applied with adhesive in response to a user operation. For example, the first remote control system may include a human-computer interaction module. A user may perform a user operation based on the human-computer interaction module to cause the first remote control system to send information about the change in the type of the product to be applied with adhesive when the type of the product to be applied with adhesive changes.

In some embodiments, at step 2024, the first amount of the adhesive that is instructed to be discharged from the adhesive nozzle by the adhesive dispensing module is determined based on the dimension of the adhesive nozzle.

For example, the first amount is positively correlated with the dimension of the adhesive nozzle. That is, the larger the dimension of the adhesive nozzle, the greater the first amount; conversely, the smaller the dimension of the adhesive nozzle, the smaller the first amount.

The first amount is flexibly adjusted based on the dimension of the adhesive nozzle, rather than a fixed value. This enables the adhesive dispensing module to complete the discharging of the first amount of adhesive in a short time under the condition of different sizes of adhesive nozzles. In this way, the time required for performing the testing inspection operation can be reduced, the efficiency of performing the testing inspection can be improved, and thus the production efficiency can be improved.

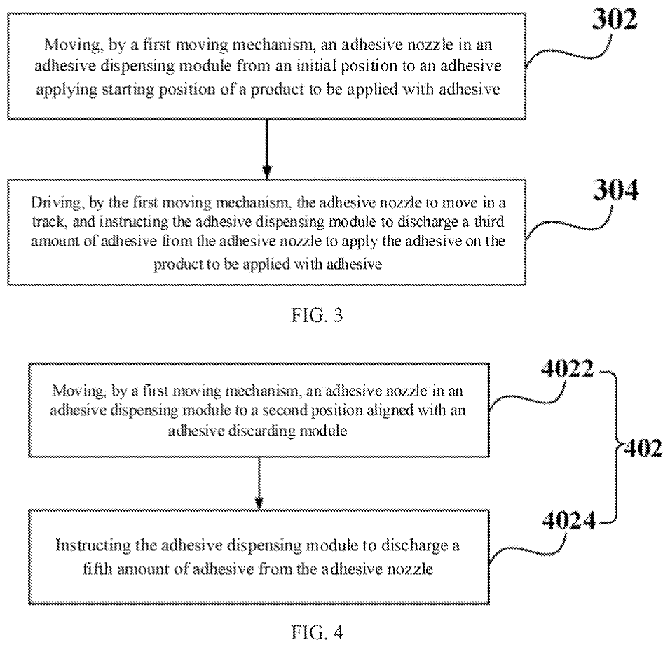

FIG. 3 is a schematic flowchart of a control method for an adhesive applying device according to some other embodiments of the present disclosure. The adhesive applying device at least includes the adhesive dispensing module 101 and the first moving mechanism 102 shown in FIG. 1.

As shown in FIG. 3, the control method for an adhesive applying device includes steps 302 to 304.

At step 302, the adhesive nozzle is moved, by the first moving mechanism, from an initial position to an adhesive applying starting position of a product to be applied with adhesive.

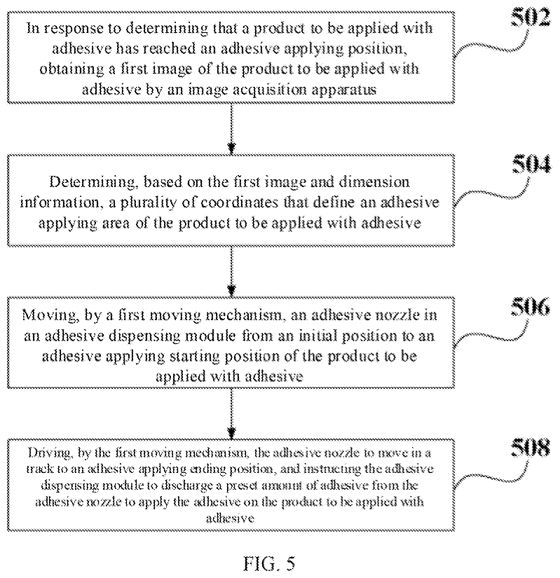

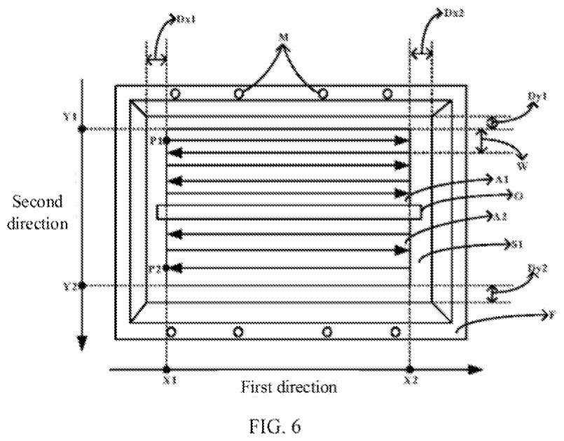

In some embodiments, in response to determining that the product to be applied with adhesive has reached an adhesive applying position, an image of the product to be applied with adhesive is obtained by an image acquisition apparatus, and the adhesive applying starting position is determined based on the image. The implementation of determining the adhesive applying starting position based on the image may refer to the later description of the control method in FIG. 5, which will not be described in detail herein. The real image of the product that has reached the adhesive applying position can be acquired on-site by the image acquisition apparatus, so that the adhesive applying starting position can be determined more accurately and the accuracy of adhesive applying can be improved.

As some implementations, the image acquisition apparatus may be mounted on the first moving mechanism to facilitate image acquisition for the product to be applied with adhesive.

At step 304, the adhesive nozzle is driven, by the first moving mechanism, to move in a track, and the adhesive dispensing module is instructed to discharge a third amount of adhesive from the adhesive nozzle to apply the adhesive on the product to be applied with adhesive.

It should be understood that different types of products to be applied with adhesive may correspond to the same or different third amounts.

As some implementations, the third amounts corresponding to different types of products to be applied with adhesive are stored in advance in a particular remote control system, such as a TOM system or an MES. In this case, the third amount corresponding to the current product to be applied with adhesive can be obtained from the remote control system to perform step 304.

In the above embodiments, by controlling the first moving mechanism, the adhesive nozzle can be moved from the initial position to the adhesive applying starting position of the product to be applied with adhesive. After the adhesive nozzle is moved to the adhesive applying starting position, the first moving mechanism is controlled to move the adhesive nozzle in a track and control the adhesive dispensing module to discharge the third amount of adhesive from the adhesive nozzle. In this way, automatic adhesive applying for the product to be applied with adhesive can be realized.

The control method shown in FIG. 3 is further described below in conjunction with some embodiments.

In some embodiments, the control method shown in FIG. 3 is performed in response to determining that the testing inspection is passed. The manner of determining that the testing inspection is passed may be the manner shown in FIG. 2.

That is, the adhesive applying device is controlled to perform adhesive applying for the product to be applied with adhesive only when the testing inspection is passed. That is, the adhesive applying device is controlled to apply the adhesive on the product to be applied with adhesive only when it is determined that the amount of adhesive discharged from the adhesive applying device is accurate. In this way, the quality of the automatic adhesive applying can be further improved.

In the above embodiments, although the adhesive applying for the product to be applied with adhesive is performed only when the testing inspection is passed (i.e., when it is determined that the amount of adhesive discharged from the adhesive applying device is accurate), it is noted that the amount of adhesive discharged from the adhesive applying device may be inaccurate as a result of wear and tear during use. In view of this, the present disclosure further proposes the following embodiments.

In some embodiments, a fourth amount of the adhesive delivered to the adhesive nozzle during adhesive applying for the product to be applied with adhesive may also be determined based on the metering of the metering module, and the adhesive dispensing module may be instructed to stop applying the adhesive on a next product to be applied with adhesive in the case where a deviation of the fourth amount relative to the third amount exceeds a second threshold.

The third amount may indicate the amount of the adhesive that the product is expected to be applied with, and the fourth amount may indicate the amount of the adhesive that the product is actually applied with. The deviation of the fourth amount relative to the third amount exceeds the second threshold, which indicates a great deviation between the amount of the adhesive that the product expects to be applied and the adhesive actually applied. In this case, the adhesive dispensing module is instructed to stop applying the adhesive on a next product to be applied with adhesive.

In the above embodiments, the accuracy of the amount of the adhesive discharged by the adhesive applying device during adhesive applying for the product is verified based on the deviation between the third amount and the fourth amount, and the adhesive dispensing module is instructed to stop applying the adhesive on a next product to be applied with adhesive in the case where the deviation of the fourth amount relative to the third amount exceeds the second threshold. In this way, the quality of the adhesive applying process can be automatically controlled to reduce the cost of errors caused by poor quality of adhesive applying.

As some implementations, the second threshold is set small enough to ensure a smaller deviation between the amount of the adhesive that the product is expected to be applied with and the amount of the adhesive that is applied actually.

As some implementations, an alarm may be issued in the case where the deviation of the fourth amount relative to the third amount exceeds the second threshold. In this case, production personnel can be notified in time to inspect and maintain the adhesive applying device.

In some embodiments, the fourth amount may also be uploaded to a second remote control system. The second remote control system may be the same as or different from the first remote control system. The second remote control system may, for example, be a TOM system or an MES.

The fourth amount is the amount of the adhesive actually delivered to the adhesive nozzle as measured by the metering module. By uploading the fourth amount to the second remote control system, it may facilitate the subsequent traceability of production data and may also help production personnel to view the production data remotely.

In some embodiments, the third amount may also be obtained from the third remote control system based on the type of the product to be applied with adhesive. The third remote control system may be the same as or different from the first remote control system. The third remote control system may, for example, be a TOM system or an MES.

For example, the type of the current product to be applied with adhesive may be determined based on information obtained, from the first remote control system, about the change in the type of the product to be applied with adhesive. Then, a corresponding third amount may be obtained from the third remote control system based on the type of the current product to be applied with adhesive to instruct the adhesive dispensing module to discharge the third amount of adhesive from the adhesive nozzle.

For another example, the production personnel can preset a corresponding relationship between the product type and the amount of adhesive in the remote control system.

By obtaining the adhesive amount information corresponding to the product type from the remote control system, the necessity of manual verification at the site of the adhesive applying device can be reduced.

In some embodiments, the adhesive nozzle is moved by the first moving mechanism to return to the initial position after the adhesive applying is completed. In this way, it is possible to prevent the adhesive nozzle from colliding with the product due to being retained in an adhesive application position, thereby improving the reliability of the adhesive applying device and the product.

In some embodiments, the second moving mechanism is instructed to transfer the product to be applied with adhesive to the adhesive applying position before the adhesive nozzle is transferred from the initial position to the adhesive applying starting position by the first moving mechanism.

The adhesive nozzle is transferred from the initial position to the adhesive applying starting position by the first moving mechanism only after the second moving mechanism has transferred the product to be applied with adhesive to the adhesive applying position. In this way, the possibility of the adhesive nozzle colliding with the product to be applied with adhesive can be reduced, thereby improving the reliability of the adhesive applying device and the product.

In some other embodiments, after the adhesive applying is completed, the second moving mechanism can be instructed to transfer the product that has been applied with adhesive away from the adhesive applying position. In this way, the possibility of the adhesive nozzle colliding with the product can be reduced, thereby improving the reliability of the adhesive applying device and the product. Moreover, an adhesive applying station can be quickly vacated automatically, without manual carrying, reducing the time for the adhesive applying device to wait for a next product to be applied with adhesive, and improving the continuity of operation.

In yet some other embodiments, the second moving mechanism is instructed to transfer the product to be applied with adhesive to the adhesive applying position before transferring the adhesive nozzle from the initial position to the adhesive applying starting position by the first moving mechanism, and the second moving mechanism is further instructed to transfer the product that has been applied with adhesive away from the adhesive applying position after the adhesive applying is completed. In this way, it is beneficial to realize the streamlined production of products.

As some implementations, the second moving mechanism may be an Automated Guided Vehicle (AGV). The AGV may have a jacking structure and the product may be placed on the jacking structure.

FIG. 4 is a schematic flowchart of a control method for an adhesive applying device according to yet some other embodiments of the present disclosure. The adhesive applying device includes at least the adhesive dispensing module 101, the first moving mechanism 102, and the adhesive discarding module 108 as shown in FIG. 1.

As shown in FIG. 4, the control method for an adhesive applying device includes step 402. At step 402, an adhesive discarding operation is performed. Step 402 includes steps 4022 to 4024.

At step 4022, an adhesive nozzle in the adhesive dispensing module is moved to a second position aligned with the adhesive discarding module by the first moving mechanism.

For example, the adhesive discarding module may include a container for containing the adhesive, with an opening provided on the upper side of the container. In this case, the adhesive nozzle can be moved by the first moving mechanism to a position directly above the opening in the container in the adhesive discarding module (i.e., the second position).

At step 4024, the adhesive dispensing module is instructed to discharge a fifth amount of adhesive from the adhesive nozzle.

For example, the adhesive discharged from the adhesive nozzle is received by the container in the adhesive discarding module.

As some embodiments, the fifth amount is different in case the dimension of the adhesive nozzle is different.

In the above embodiments, after the adhesive nozzle is moved, by the first moving mechanism, to the second position aligned with the adhesive discarding module, the adhesive dispensing module is instructed to discharge the fifth amount of adhesive from the adhesive nozzle. In this way, the adhesive applying device can be controlled to automatically discharge discarded adhesive without manual operation, thereby reducing labor costs.

As shown in FIG. 4, the control method for an adhesive applying device is further described below in conjunction with some embodiments.

In some embodiments, an adhesive discarding operation can be performed when the fulfillment of a second criterion is detected. The second criterion may include that no adhesive is discharged from the adhesive nozzle within a second preset duration.

That is, in the case where no adhesive is discharged from the adhesive nozzle within the second preset duration, the adhesive discarding operation is performed, so that the adhesive is discharged from the adhesive nozzle to the adhesive discarding module.

The adhesive nozzle is prone to being blocked due to solidification of the adhesive in the case where no adhesive is discharged within a certain duration. By detecting that no adhesive is discharged from the adhesive nozzle within the second preset duration, the adhesive is controlled to be discharged from the adhesive nozzle to the adhesive discarding module. In this way, the possibility of the adhesive nozzle being blocked due to the solidification of the adhesive can be reduced, thereby improving the reliability of the adhesive applying device.

In some embodiments, the fifth amount is associated with a duration in which no adhesive is discharged since the last discharging of adhesive from the adhesive nozzle.

For example, the fifth amount is positively correlated with the duration in which no adhesive is discharged since the last discharging of adhesive from the adhesive nozzle. That is, the longer the duration that no adhesive is discharged from the adhesive nozzle since the last discharging of the adhesive, the greater the fifth amount is; conversely, the shorter the duration that no adhesive is discharged from the adhesive nozzle since the last discharging of the adhesive, the smaller the fifth amount is.

The fifth amount is flexibly adjusted based on the duration in which no adhesive is discharged since the last discharging of adhesive from the adhesive nozzle, rather than a fixed value. In this way, the possibility of the adhesive nozzle being blocked due to the solidification of the adhesive can be reduced, thereby improving the reliability of the adhesive applying device.

FIG. 5 is a schematic flowchart of a control method for an adhesive applying device according to still some other embodiments of the present disclosure. The adhesive applying device at least includes the adhesive dispensing module 101 and the first moving mechanism 102 shown in FIG. 1.

As shown in FIG. 5, the control method for an adhesive applying device includes steps 502 to 508.

At step 502, in response to determining that a product to be applied with adhesive has reached the adhesive applying position, a first image of the product to be applied with adhesive is obtained by an image acquisition apparatus.

As some implementations, the product to be applied with adhesive is transferred to the adhesive applying position by the second moving mechanism.

At step 504, a plurality of coordinates that define an adhesive applying area of the product to be applied with adhesive are determined based on the first image and dimension information.

Herein, the plurality of coordinates include a first starting point coordinate and a first ending point coordinate in a first direction, and a second starting point coordinate and a second ending point coordinate in a second direction.

For example, in the case where the area to be applied with adhesive is rectangular, the first direction and the second direction are X and Y directions perpendicular to each other, respectively.

At step 506, the adhesive nozzle is moved, by the first moving mechanism, from an initial position to an adhesive applying starting position of a product to be applied with adhesive.

Here, the adhesive applying starting position is determined based on the first starting point coordinate and the second starting point coordinate.

At step 508, the adhesive nozzle is driven, by the first moving mechanism, to move to an adhesive applying ending position in a track, and the adhesive dispensing module is instructed to discharge a third amount of adhesive from the adhesive nozzle to apply the adhesive on the product to be applied with adhesive.

Here, the adhesive applying ending position is determined based on the first starting point coordinate and the second ending point coordinate.

For example, in the case where the area to be applied with adhesive is rectangular, the adhesive applying starting position may be a point proximate to a vertex of the area to be applied with adhesive as determined based on the first starting point coordinate and the second starting point coordinate, and the adhesive applying ending position may be a point proximate to another vertex of the area to be applied with adhesive as determined based on the first starting point coordinate and the second ending point coordinate. A connecting line between the adhesive applying starting position and the adhesive applying ending position belongs to an edge of the area to be applied with adhesive.

In the above embodiments, the plurality of coordinates that define the adhesive applying area of the product to be applied with adhesive are determined based on the first image and dimension information of the product to be applied with adhesive at the adhesive applying position, so that the adhesive nozzle can be moved accurately from the applying starting position to the applying ending position in a track by controlling the adhesive nozzle through the first moving mechanism based on the plurality of coordinates. In this way, the degree of automation and the quality of adhesive applying can be improved.

As shown in FIG. 5, the control method for an adhesive applying device is further described below in conjunction with some embodiments.

In some embodiments, a second image of the product that has been applied with adhesive is obtained by the image acquisition apparatus after the adhesive applying is completed. Next, a first area in which the adhesive is applied is determined based on the second image. In the case where the first area is smaller than second area of the product required to be applied with adhesive, the adhesive dispensing module is instructed to continue to discharge adhesive from the adhesive nozzle to supplement adhesive for the product.

In this way, when the area applied with adhesive does not meet the requirements, the adhesive can be supplemented to apply on the product in time.

In some embodiments, at step 508, the first moving mechanism drives the adhesive nozzle to move in a track at a first velocity. Here, the first velocity is determined based on a second velocity, the second velocity being a velocity at which the adhesive discharge module discharges a preset amount of adhesive from the adhesive nozzle in step 508.

By associating a moving velocity of the adhesive nozzle with an adhesive discharging velocity, the discharging of the preset amount of adhesive can be realized more accurately, thereby meeting the quality requirements for adhesive applying.

As some implementations, the first velocity is positively correlated with the second velocity.

For example, the relationship between the first velocity V1 and the second velocity V2 can be expressed by the following equation: V1/V2=L×S×ρ/m. In the equation, L is the total length of an adhesive applying track, S is the adhesive applying area, ρ is the adhesive density, and m is the weight of adhesive.

In some embodiments, the area to be applied with adhesive belongs to a first surface of the product to be applied with adhesive. In this case, the dimension information in step 504 may include first information and second information. The first information indicates a distance between a boundary of the area to be applied with adhesive and a boundary of the first surface. The second information indicates the dimension of the adhesive nozzle.

As some implementations, the area to be applied with adhesive includes a plurality of sub-regions, two adjacent sub-areas of the plurality of sub-areas being spaced apart by an opening in the first surface. In this case, the dimension information may further include third information indicating the dimension and location of the opening. In this way, in the case where the surface of the product to be applied with adhesive has the opening, the adhesive applying track can still be accurately calculated.

For ease of understanding, some implementations of step 504 are described below with reference to FIG. 6. FIG. 6 is a schematic diagram of a first image according to some embodiments of the present disclosure.

As shown in FIG. 6, the first image includes a first surface S1 of a product to be applied with adhesive. The first surface S1 has an opening O that separates the area to be applied with adhesive into sub-areas A1 and A2.

An auxiliary positioning structure F is arranged outside the first surface S1. The auxiliary positioning structure F is provided with a plurality of hole-like structures M for auxiliary positioning.

In this case, the first information of the dimension information indicates distances Dx1, Dx2, Dy1 and Dy2 between the boundary of the area to be applied with adhesive and the boundary of the first surface S1 of the product to be applied with adhesive defined by the auxiliary positioning structure F.

The second information of the dimension information indicates the dimension of the adhesive nozzle, the dimension of the adhesive nozzle can be used for determining an applying width W in the adhesive applying process.

The third information of the dimension information indicates a dimension of the opening O and location of the opening O on the first surface S1.

Under the example shown in FIG. 6, a first starting point coordinate X1 and a first ending point coordinate X2 in the first direction may be determined based on the first image in combination with the distance Dx1 and the distance Dx2 in the first information of the dimension information. In addition, a second starting point coordinate Y1 and a second ending point coordinate Y2 in the second direction may be determined based on the first image in combination with the distance Dy1 and the distance Dy2 in the first information of the dimension information.

After the plurality of coordinates are determined, an adhesive applying starting position P1 of the product to be applied with adhesive may be determined based on the first starting point coordinate X1 and the second starting point coordinate Y1, and an adhesive applying ending position P2 of the product to be applied with adhesive may be determined based on the first starting point coordinate X1 and the second ending point coordinate Y2.

Illustratively, both the adhesive applying starting position P1 and the adhesive applying ending position P2 have coordinates in the first direction that are equal to the first starting point coordinate X1. The coordinates of the adhesive applying starting position P1 in the second direction are determined based on the second starting point coordinate Y1 and the applying width W, for example, being equal to Y1 plus W/2. The coordinates of the adhesive applying ending position P2 in the second direction are determined based on the second ending point coordinate Y2 and the applying width W, for example, being equal to Y2 minus W/2.

In this way, the adhesive applying starting position P1 and the adhesive applying ending position P2 can be accurately determined.

After the adhesive applying starting position P1 is determined, the adhesive nozzle can be moved by the first moving mechanism from the initial position to the adhesive applying starting position P1 of the product to be applied with adhesive. Then, the adhesive nozzle is moved by the first moving mechanism to the adhesive applying ending position P2 in a track (i.e., a plurality of lines with arrows in the area to be applied with adhesive as shown in FIG. 6).

The control method shown in FIG. 5 may further include other embodiments, and where relevant, reference may be made to the embodiments of the control method shown in FIG. 2. This will not be repeated herein.

It should be understood that the control methods for an adhesive applying device of the above embodiments may be combined in any way. For example, the control method for an adhesive applying device may include the processes shown in FIGS. 2 and 3 above; and for another example, the control method for an adhesive applying device may include the processes shown in FIGS. 3 and 4 above. The list is not exhaustive.

The present disclosure further provides a control module for an adhesive applying device. The control module may be, for example, the control module 104 shown in FIG. 1.

In some embodiments, the control module for the adhesive applying device includes a unit for performing the control method for an adhesive applying device according to any of the above embodiments.

In other embodiments, the control module for the adhesive applying device includes a memory and a processor coupled to the memory, the processor being configured to execute the control method for an adhesive applying device according to any of the above embodiments based on instructions stored in the memory.

The memory may, for example, include a system memory, a fixed non-volatile storage medium, and the like. The system memory may stores, for example, an operating system, an application program, a Boot Loader, and other programs.

The control module may further include an input/output interface, a network interface, a memory interface, and the like. These interfaces may be connected to each other, and between the memory and the processor, for example, via a bus. The input/output interface provides a connection interface for input/output devices such as a display, a mouse, a keyboard, and a touch screen. The network interface provides a connection interface for various networked devices. The storage interface provides a connection interface for an external storage device such as an SD card, and a USB flash drive.

As some implementations, the control module for the adhesive applying device according to any of the above embodiments may be a PLC.

The present disclosure further provides an adhesive applying device, including at least one module of the adhesive applying device 100 shown in FIG. 1, and a control module for the adhesive applying device according to any of the above embodiments.

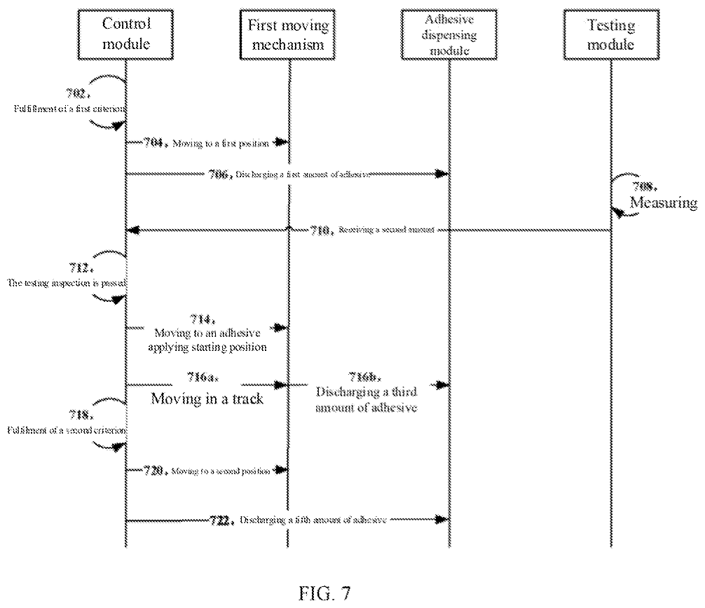

An operating procedure of the adhesive applying device of these embodiments is described below with reference to FIG. 7. FIG. 7 is a schematic diagram of an operating procedure of an adhesive applying device according to some embodiments of the present disclosure.

As shown in FIG. 7, the operating procedure of the adhesive applying device includes steps 702 to 722.

At step 702, the control module detects the fulfillment of a first criterion.

For example, the first criterion refers to initial start of the adhesive applying device. For another example, the first criterion refers to a first preset duration since the last time the fulfillment of the first criterion is detected. For another example, the first criterion refers to a change in the type of a product to be applied with adhesive.

At step 704, the control module controls to move, by the first moving mechanism, the adhesive nozzle in the adhesive dispensing module to a first position aligned with the testing module.

At step 706, the adhesive dispensing module is instructed to discharge a first amount of adhesive from the adhesive nozzle after the adhesive nozzle is moved to a first position aligned with the testing module.

At step 708, the testing module measures the received adhesive to obtain a second amount.

As some implementations, the testing module is instructed to measure the received adhesive after determining that the first amount of adhesive has been discharged by the adhesive dispensing module. As some other implementations, the testing module automatically measures the received adhesive in the case where the discharging of the first amount of adhesive has been completed.

At step 710, the control module receives the second amount measured by the measurement module.

At step 712, the control module determines that the adhesive applying device passes the testing inspection in the case where a deviation of the second amount relative to the first amount does not exceed a first threshold.

By performing steps 702 to 712, the adhesive applying device can automatically complete a first piece inspection.

At step 714, the control module controls to move the adhesive nozzle by the first moving mechanism from an initial position to an adhesive applying starting position of a product to be applied with adhesive.

As some implementations, step 714 may be performed in response to step 712.

As some other implementations, the adhesive applying starting position may be determined according to the embodiments related to FIG. 5.

At step 716a, the control module drives the adhesive nozzle to move in a track by the first moving mechanism.

For example, the control module may drive the adhesive nozzle via the first moving mechanism to move from the adhesive applying starting position P1 to the adhesive applying ending position P2 follow the track shown in FIG. 6.

At step 716b, the control module instructs the adhesive dispensing module to discharge a third amount of adhesive from the adhesive nozzle to apply the adhesive on the product to be applied with adhesive during the period in which the first moving mechanism drives the adhesive nozzle to move in a track.

By performing step 714, step 716a, and step 716b, the adhesive applying device can automatically apply the adhesive on the product to be applied with adhesive.

At step 718, the control module detects the fulfillment of a second criterion.

The second criterion may include that no adhesive is discharged from the adhesive nozzle within a second preset duration.

At step 720, when the fulfillment of the second criterion is detected, the control module moves the adhesive nozzle to a second position aligned with the adhesive discarding module by the first moving mechanism.

At step 722, after the adhesive nozzle moves to the second position aligned with the adhesive discarding module, the control module instructs the adhesive dispensing module to discharge a fifth amount of adhesive from the adhesive nozzle.

By performing steps 718 to 722, the adhesive applying device can automatically discharge the discarded adhesive.

It is to be understood that the operating procedure shown in FIG. 7 is merely illustrative and not limiting. For example, the steps do not need to be performed in the sequence shown in FIG. 7. For another example, the operating procedure of the adhesive applying device may further include only one or more of the steps shown in FIG. 7. For another example, the operating procedure of the adhesive applying device may include steps other than those shown in FIG. 7. Relevant aspects can be found in the previous embodiments relating to FIGS. 2 to 5, which will not be repeated herein.

Although the present disclosure has been described with reference to the preferred embodiments, various improvements can be made thereto and components thereof can be replaced with equivalents without departing from the scope of the present disclosure. In particular, the technical features mentioned in the various embodiments can be combined in any manner as long as there is no structural conflict. The disclosure is not limited to the particular examples disclosed herein, and includes all technical solutions falling within the scope of the claims.

What is claimed is:

1. A control method for an adhesive applying device, the adhesive applying device comprising an adhesive dispensing module, a first moving mechanism and a testing module, the control method comprising:
performing a testing inspection operation;
wherein the testing inspection operation comprises:
moving, by the first moving mechanism, an adhesive nozzle in the adhesive dispensing module to a first position aligned with the testing module;
instructing the adhesive dispensing module to discharge a first amount of adhesive from the adhesive nozzle;
receiving a second amount of adhesive from the testing module, wherein the second amount of adhesive is obtained based on measuring the received adhesive using the testing module; and
determining that the adhesive applying device passes the testing inspection in the case where a deviation of the second amount of adhesive relative to the first amount of adhesive does not exceed a first threshold.

2. The control method according to claim 1, wherein the testing inspection operation is performed when a fulfillment of a first criterion is detected, wherein the first criterion comprises at least one of the following:
initial start of the adhesive applying device;
a first preset duration since the last execution of the testing inspection operation; and
a change in the type of a product to be applied with the adhesive.

3. The control method according to claim 2, further comprising:
obtaining, from a first remote control system, information about the change in the type of the product to be applied with the adhesive.

4. The control method according to claim 1, wherein the first amount of adhesive is determined based on a dimension of the adhesive nozzle.

5. The control method according to claim 1, wherein the adhesive dispensing module comprises a metering module, the metering module being configured to meter the adhesive delivered to the adhesive nozzle, the control method further comprising:
in response to determining via the metering module that the discharging of the first amount of adhesive has been completed, instructing the testing module to measure the received adhesive to obtain the second amount of adhesive.

6. The control method according to claim 1, wherein the testing module is configured to:
detect whether or not the discharging of the first amount of adhesive has been completed; and
in response to detecting that the discharging of the first amount of adhesive has been completed, measure the received adhesive to obtain the second amount of adhesive.

7. The control method according to claim 1, further comprising:
in response to determining that the testing inspection is passed, moving, by the first moving mechanism, the adhesive nozzle from an initial position to an adhesive applying starting position of a product to be applied with the adhesive; and
driving, by the first moving mechanism, the adhesive nozzle to move in a track, and instructing the adhesive dispensing module to discharge a third amount of adhesive from the adhesive nozzle to apply the adhesive on the product to be applied with the adhesive.

8. The control method according to claim 7, wherein the adhesive dispensing module further comprises a metering module, the metering module being configured to meter the adhesive delivered to the adhesive nozzle, the control method further comprising:
determining, based on the metering of the metering module, a fourth amount of the adhesive delivered to the adhesive nozzle during adhesive applying for the product to be applied with the adhesive; and
instructing the adhesive dispensing module to stop applying the adhesive on a next product to be applied with the adhesive in the case where a deviation of the fourth amount of adhesive relative to the third amount of adhesive exceeds a second threshold.

9. The control method according to claim 8, further comprising:
uploading the fourth amount of adhesive to a second remote control system.

10. The control method according to claim 7, further comprising:
obtaining the third amount of adhesive from a third remote control system based on the type of the product to be applied with the adhesive.

11. The control method according to claim 7, further comprising:
moving, by the first moving mechanism, the adhesive nozzle to return to the initial position after the adhesive applying is completed.

12. The control method according to claim 7, further comprising:
after the adhesive applying is completed, instructing a second moving mechanism to transfer the product that has been applied with the adhesive away from an adhesive applying position.

13. The control method according to claim 7, further comprising:
instructing a second moving mechanism to transfer the product to be applied with the adhesive to an adhesive applying position before transferring the adhesive nozzle from the initial position to the adhesive applying starting position by the first moving mechanism.

14. The control method according to claim 7, further comprising:
in response to determining that the product to be applied with the adhesive has reached an adhesive applying position, obtaining an image of the product to be applied with the adhesive by an image acquisition apparatus; and
determining the adhesive applying starting position based on the image.

15. The control method according to claim 1, wherein the adhesive applying device further comprises an adhesive discarding module, the control method further comprising:
performing an adhesive discarding operation;
wherein the adhesive discarding operation comprises:
moving, by the first moving mechanism, the adhesive nozzle to a second position aligned with the adhesive discarding module; and
instructing the adhesive dispensing module to discharge a fifth amount of adhesive from the adhesive nozzle.

16. The control method according to claim 15, wherein the adhesive discarding operation is performed when a fulfillment of a second criterion is detected, wherein the second criterion comprises that no adhesive is discharged from the adhesive nozzle within a second preset duration.

17. The control method according to claim 15, wherein the fifth amount of adhesive is associated with a duration in which no adhesive is discharged since the last discharging of the adhesive from the adhesive nozzle.

18. A control method for an adhesive applying device, the adhesive applying device comprising an adhesive dispensing module and a first moving mechanism, the method comprising:
in response to determining that a product to be applied with an adhesive has reached an adhesive applying position, obtaining a first image of the product to be applied with the adhesive by an image acquisition apparatus; and
determining, based on the first image and dimension information of the product, a plurality of coordinates that define an adhesive applying area of the product to be applied with the adhesive, the plurality of coordinates comprising a first starting point coordinate and a first ending point coordinate in a first direction, and a second starting point coordinate and a second ending point coordinate in a second direction;
moving, by the first moving mechanism, an adhesive nozzle in the adhesive dispensing module from an initial position to an adhesive applying starting position of the product to be applied with the adhesive, wherein the adhesive applying starting position is determined based on the first starting point coordinate and the second starting point coordinate; and
driving, by the first moving mechanism, the adhesive nozzle to move in a track to an adhesive applying ending position, and instructing the adhesive dispensing module to discharge a preset amount of adhesive from the adhesive nozzle to apply the adhesive on the product to be applied with the adhesive, wherein the adhesive applying ending position is determined based on the first starting point coordinate and the second ending point coordinate.

19. The control method according to claim 18, further comprising:
obtaining, by the image acquisition apparatus, a second image of the product that has been applied with the adhesive after the adhesive applying is completed;
determining, based on the second image, a first area in which the adhesive is applied; and
in the case where the first area is smaller than a second area of the product required to be applied with the adhesive, instructing the adhesive dispensing module to continue to discharge the adhesive from the adhesive nozzle to supplement the adhesive to apply it on the product.

20. An adhesive applying device, comprising:
an adhesive dispensing module, comprising an adhesive nozzle;
a first moving mechanism;
a testing module; and
a control module;
wherein
the adhesive dispensing module is configured to discharge an adhesive via the adhesive nozzle;
the first moving mechanism is configured to move the adhesive nozzle of the adhesive discharge module to a first position aligned with the testing module;
the testing module is configured to receive and measure the adhesive; and
the control module, communicatively coupled to the adhesive dispensing module, the first moving mechanism and the testing module, is configured to:
instruct the adhesive dispensing module to discharge a first amount of adhesive from the adhesive nozzle;
receive a second amount of adhesive from the testing module, wherein the second amount of adhesive is obtained based on measuring the received adhesive using the testing module; and
determine that the adhesive applying device passes the testing inspection when a deviation of the second amount of adhesive relative to the first amount of adhesive does not exceed a first threshold.
